(19) United States
(12) Patent Application Publication
(10) Pub. No.: US 2014/0308182 A1
(43) Pub. Date: Oct. 16, 2014

(54) Method for Concentrating Metal Chlorides in and Separating Same from an Iron(III) Chloride-Containing Hydrochloric Acid Solution

(71) Applicant: SMS SIEMAG PROCESS TECHNOLOGIES GMBH, Vienna (AT)

(72) Inventors: Herbert Weissenbaeck, Vienna (AT); Dieter Vogl, Wolfpassing (AT)

(73) Assignee: SMS SIEMAG PROCESS TECHNOLOGIES GMBH, Vienna (AT)

(21) Appl. No.: 14/365,907

(22) PCT Filed: Dec. 12, 2012
(86) PCT No.: PCT/AT2012/050195

§ 371 Date: Jun. 16, 2014

(30) Foreign Application Priority Data
Dec. 16, 2011 (AT) A 1838/2011
May 25, 2012 (AT) A 50205/2012

(51) Int. Cl. C01B 7/07; C01G 49/10; C01G 49/06

(52) U.S. Cl. CPC C01B 7/0737; C01G 49/06; C01G 49/10
USPC 423/139; 423/140; 423/488

(57) ABSTRACT

A method for concentrating metal chlorides in and separating same from an iron(III) chloride-containing hydrochloric acid solution is described, wherein iron is precipitated from the solution as iron oxide, preferably haematite and filtered off in a filtration device, and the now further concentrated non-hydrolysable metal chlorides are removed from at least a part of the hydrochloric acid filtrate.

The present invention relates to a method for concentrating metal chlorides in and separating same from an iron(III) chloride-containing hydrochloric acid solution.

Iron-containing hydrochloric acid solutions are produced in a wide range of processes, inter alia in the case of pickling in the steel industry, where the scale is removed by means of chemical reaction with hydrochloric acid. Iron-containing hydrochloric acid solutions are also produced however in the nonferrous industry, where a wide range of ores are dissolved in hydrochloric acid and the nonferrous metals are obtained in a subsequent hydrometallurgical process. Since iron is practically always present in the ores, iron-containing hydrochloric acid solutions are also produced here. There are a wide range of backgrounds and needs for the separation of metal chlorides from iron(III) chloride-containing solutions.

For reasons of economic viability, operators of production plants in which iron chlorides are produced as waste product aim to recover the hydrochloric acid in a regeneration process and therefore to produce a closed chloride circuit at the location of the production plant.

In industrial processes the iron-containing hydrochloric acid solutions produced are not usually present in pure form. In the case of iron-containing hydrochloric acid solutions from pickling processes in the steel industry, said hydrochloric acid solution is contaminated by the alloy elements present in the steel, for example Mn, Zn, Ni, etc. Here, the objective of the operator is to remove said alloy elements from the closed chloride circuit between the production plant and the regeneration process so as to prevent the accumulation of the contaminant. In hydrometallurgical processes, the objective is slightly different; here, the contaminants contained in low concentrations in the iron-containing hydrochloric acid solution are substances of value that are to be extracted.

In the case of the conventional recovery method for the recovery of hydrogen chloride from iron-containing hydrochloric acid solutions, a distinction is made between pyrohydrolytic and hydrothermal methods.

The two known pyrohydrolytic methods are the Ruthner method, also known as the spray roasting method, and the Lurgi method, also known as the fluidised bed method. Fundamentally, both methods function by the same principle, wherein they differ primarily in the design of the roaster. The iron chloride solution produced is injected directly into a furnace fired by fuel, the water present in the iron chloride solution is evaporated, and the iron chloride reacts with water and, in the case of iron(II) chloride also with oxygen, to form iron oxide in the form of haematite, which is discharged continuously from the reactor, and hydrogen chloride, which is discharged in gaseous form from the reactor with the steam and the burn-off originating from the combustion. In the case of a spray roaster, the iron chloride solution is sprayed finely from above into the reactor, and the iron oxide powder that forms falls downwards and is removed. The exit temperature of the roaster gas is typically set to approximately 400° C.

In the Lurgi method a fluidised bed furnace is used as a roaster furnace. Here, the burn-off of the combustion required for the process is used as a fluidisation medium. The produced iron oxide granulate is used as bed material. The iron chloride solution is applied in a non-pressurised manner to the fluidised bed by means of lances. Here, the iron oxide granulate is wetted with the iron chloride solution, and the iron chloride solution is roasted and iron oxide is produced in the form of haematite and hydrochloric acid. Due to the high temperature of 850° C., the newly formed iron oxide layer is sintered with the basic material, and the iron oxide granulate grows. Iron oxide granulate is removed continuously from the reactor so as to keep the bed height constant. Similarly to the Ruthner method, the formed hydrogen chloride is removed in gaseous form from the reactor with the steam and the burn-off of the combustion.

In both methods the roaster gases are first cooled in a Venturi evaporator, wherein the iron chloride solution is used as coolant and is concentrated here by evaporation. The resultant concentrated iron chloride solution is injected into the roaster.

The hydrogen chloride is washed out from the cooled roaster gas in a multi-stage gas scrubbing. Here, hydrochloric acid is produced, which can be used in turn in the original production process.

In the case of the pyrohydrolytic regeneration method, the hydrolysis does not take place in the aqueous phase. The acid is injected into the reactor, the water evaporates, and the metal chlorides contained in the iron-containing hydrochloric acid solution crystallise out and are roasted. This means that the metal chlorides react with the water in the furnace atmosphere to form metal oxides and release hydrogen chloride. An advantage with this method is that the majority of the contaminants present in the iron-containing hydrochloric acid solution are roasted under these conditions and are therefore ejected from the closed chloride circuit. Even elements that cannot be roasted, such as K, Ca and Na, are ejected as chloride contaminants in the oxide.

Metal chlorides with low sublimation temperature, such as ZnCl₂ or FeCl₃, are not suitable for this method, since these metal chlorides are removed as vapour from the reactor and condense out in cooler regions of the plant and form very fine particles, which lead to deposits and clogging in the exhaust gas flue.

In AT 315 603 B (method for regenerating zinc-containing hydrochloric acid iron pickling solutions), a method is described in which an iron-containing hydrochloric acid solution contaminated by zinc chloride, such as a pickling solution from galvanic processes, is processed by addition of sulphuric acid in a spray roaster, wherein the zinc is present in the produced iron oxide as zinc sulphate.

A further method for processing iron chloride solutions is constituted by hydrothermal regeneration, where haematite is precipitated directly from the iron(III) chloride solution. This means that dissolved iron(III) chloride reacts with water to form haematite and hydrogen chloride. The hydrogen chloride is driven from the solution by evaporation. Since the hydrogen chloride is removed continuously from the reaction equilibrium, the hydrolysis reaction is driven by iron(III) chloride.

The hydrolysis of iron(III) chloride is described in U.S. Pat. No. 3,682,592 B in what is known as the PORI process. Here, an iron(II) chloride solution originating from steel pickling is concentrated in a first method step and is then oxidised by means of oxygen to form an iron(III) chloride solution. The energy required for the evaporation in the hydrolysis reactor is provided by the burn-off of a combustion. Energy is introduced into the reactor by direct contact between the iron(III) chloride solution and the hot burn-off. The hydrogen chloride is washed out from the waste gas in a gas scrubber, and the hydrochloric acid solution is recovered.

JP 2006-137118 describes a method for regenerating iron chloride solutions in accordance with the hydrothermal principle, in which the hydrolysis is performed at a temperature from 120° C. to 150° C. and at negative pressure so as to lower the boiling temperature of the iron(III) chloride solution. In contrast to the PORI process, the energy required for the evaporation is introduced into the hydrolysis reactor indirectly via heat exchanger. However, tests have shown that the iron oxide precipitated from the solution does not have the desired quality. By applying a negative pressure to lower the boiling temperature of the iron(III) chloride solution in the hydrolysis reactor, said iron(III) chloride solution has a high iron(III) chloride concentration due to the vapour/liquid equilibrium, and therefore iron oxychloride, which is unfavourable, is formed instead of haematite due to the lack of water.

In the method according to WO 2009/153321, the hydrolysis reactor is operated at atmospheric pressure, and energy is fed indirectly by a heat exchanger. Two further method steps are arranged before the hydrolysis. Firstly, the iron chloride solution is concentrated, wherein the energy required for this is provided by condensation energy of the vapours from the hydrolysis reactor. Due to the clever use of internal process heat, the energy consumption of the hydrothermal regeneration can be reduced by half compared with the pyrohydrolytic method.

The contaminants contained in the iron-containing hydrochloric acid solution, for example Mn, Zn, Ca, K, Mg, Na, etc., cannot generally be hydrolysed in the aqueous solution, as a result of which said elements are concentrated in the hydrolysis reactor. With increasing concentration of the non-hydrolysable metals, however, the vapour/liquid equilibrium also changes, whereby the concentration of the non-hydrolysable metals is acceptable up to a certain point.

Generally, the alloy elements contained in the iron-containing hydrochloric acid solution from the steel pickling are not of economic value. This thus presents a disadvantage compared with the pyrohydrolytic regeneration method, where said alloy elements are ejected from the closed chloride circuit and can be utilised. Some of the hydrolysis solution is currently discarded continuously so as to be able to adjust the concentration of the non-hydrolysable metals. Here, utilisable iron(III) chloride is also discarded, whereby the degree of recovery of hydrogen chloride is reduced. The greater the degree of concentration of the non-hydrolysable metals in the iron-containing hydrochloric acid solution in the hydrolysis reactor, the lower is the proportion of the iron-containing hydrochloric acid solution to be discarded. In spite of the lower degree of recovery of hydrogen chloride compared with the pyrohydrolytic regeneration methods, the hydrothermal regeneration is economical due to the energy efficiency.

In hydrometallurgical methods the objective is to recover the metal chlorides present in the iron-containing hydrochloric acid solution as substances of value, for example: Li, Be, Al, Sc, Ti, V, Cr, Mn, Co, Ni, Cu, Zn, Ga, Ge, As, Rb, Sr, Y, Zr, Nb, Mo, Tc, Ru, Rh, Pd, Ag, Cd, In, Sn, Sb, Te, Cs, Ba, La, Ce, Pr, Nd, Pm, Sm, Eu, Gd, Tb, Dy, Ho, Er, Tm, Yb, Lu, Hf, Ta, W, Re, Os, Ir, Pt, Au, Hg, Tl, Pb, Bi, Po, Fr, Ra, Ac, Th, Pa, U, Np and Pu. Here, due to the hydrolysis of iron(III) chloride in the aqueous solution, the dissolved iron can be precipitated from the aqueous solution as iron oxide, preferably haematite, whereas non-hydrolysable metals remain dissolved as chlorides in the aqueous solution.

The present invention concerns a method for concentrating metal chlorides in and separating same from an iron(III) chloride-containing hydrochloric acid solution, wherein iron is precipitated from the solution as iron oxide, preferably haematite, and is filtered off in a filtration device, and the now further concentrated non-hydrolysable metal chlorides are removed from at least part of the hydrochloric acid filtrate. The concentration of the non-hydrolysable metal chlorides in the concentrated iron-containing hydrochloric acid solution is at most 30% by weight, preferably at most 20% by weight, wherein the concentration of the iron(III) chloride in said solution is 30 to 80% by weight, preferably 40% by weight to 75% by weight.

The method according to the invention can be performed continuously or in batches; hereinafter, for the sake of simplicity, reference will be made to a continuous method sequence. A person skilled in the art can also perform this continuous method readily in batches with suitable modifications. An iron-containing hydrochloric acid solution mixed with metal chlorides, wherein the dissolved iron is present largely in trivalent form, is conveyed into a hydrolysis reactor. There, the hydrolysis reaction takes place, in which the iron(III) chloride present in the iron-containing hydrochloric acid solution reacts with water to form hydrogen chloride and iron oxide, preferably haematite. Said hydrolysis reaction is an equilibrium reaction, and, in order to keep the reaction running, the hydrogen chloride has to be driven out from the solution continuously. The vapour/liquid equilibrium is altered by the presence of the non-hydrolysable metal chlorides (see Examples 1 and 2), and therefore the operating conditions in the hydrolysis reactor are to be considered from new viewpoints. The hydrolysis reactor is operated here at temperatures from 150° C. to 300° C., preferably at temperatures from 160° C. to 200° C., at a pressure from −0.8 bar to 20 bar, preferably at −0.5 to 10 bar. The hydrogen chloride concentration in the hydrolysis vapour is 10 to 40% by weight, preferably 15 to 35% by weight.

By adding thermal energy, water and hydrogen chloride are evaporated during operation. Some of the solution is then removed from the hydrolysis reactor, and the iron oxide, preferably haematite, precipitated from the solution is filtered off in a filtration device. In a further method step the now further concentrated non-hydrolysable metal chlorides are removed from at least part of the iron-containing hydrochloric acid filtrate. Here, it is possible for said iron-containing hydrochloric acid solution to be cooled and/or diluted with water before the further method step so as to prevent uncontrolled crystallisation of iron(III) chloride. In a variant according to the invention, said iron-containing hydrochloric acid solution can be cooled and/or diluted with water even before the filtration of precipitated iron oxide, preferably haematite. The part of said filtrate not treated further is pumped back into the hydrolysis reactor (or into another method step upstream in the process).

In accordance with a preferred embodiment of the present invention, in order to separate off the concentrated non-hydrolysable metal chlorides from the filtered-off iron-containing hydrochloric acid solution, the individual metal chlorides are recovered selectively by means of solvent extraction from the reactor. The remaining iron-containing hydrochloric acid solution is pumped back into the hydrolysis reactor or into another method step upstream in the process. In a stripping process, said metal chlorides are then extracted back from the organic phase, for example into an aqueous phase. The organic phase is recovered and used for further solvent extraction.

As a result of this method it is now possible to increase the degree of recovery of hydrogen chloride in the case of hydrothermal acid regeneration, since no iron-containing hydrochloric acid solution is discarded. A further key advantage of this method is that the concentration of non-hydrolysable metal chlorides in the iron-containing hydrochloric acid solution is potentially extremely low, and it is possible for the first time as a result of the present invention to concentrate these said metal chlorides in the iron-containing hydrochloric acid solution and to recover same by means of solvent extraction.

With the method according to the invention it is also favourable if, for each metal chloride to be extracted from the iron-containing hydrochloric acid solution, the solvent extraction method tailored for said metal chloride is performed in series.

In accordance with a further preferred embodiment of the present invention, the iron(III) chloride contained in the iron-containing hydrochloric acid filtrate is extracted directly by means of solvent extraction and the individual non-hydrolysable metal chlorides are then recovered selectively by means of solvent extraction from the resultant iron-free solution.

In a further alternative embodiment of the present invention, in order to separate off the concentrated non-hydrolysable metal chlorides from the filtered-off iron-containing hydrochloric acid solution, the individual metal chlorides are recovered selectively by means of ion exchanger from the reactor.

In the method according to the invention, the concentrated non-hydrolysable metal chlorides from the iron-containing hydrochloric acid solution are preferably precipitated by increasing the concentration of free hydrogen chloride in the solution. Whereas the solubility of iron(III) chloride in aqueous solution is hardly influenced with increasing concentration of free hydrogen chloride, the solubility of non-hydrolysable metal chlorides, such as Ni or Zn, decreases. The metal chloride precipitated in this way is filtered and optionally washed with concentrated hydrochloric acid, and the recovered filtrate and the washing liquid can be fed back into the hydrolysis reactor or into another prior process step.

With the method variant according to the invention, in which non-hydrolysable metal chlorides are crystallised by increasing the concentration of free hydrochloric acid in the iron-containing hydrochloric acid solution, the presence of iron(III) chloride in said solution has proven to be particularly advantageous. High concentrations of iron(III) chloride in the iron-containing hydrochloric acid solution reduces the solubility of the non-hydrolysable metal chlorides in accordance with the free hydrochloric acid compared with the pure metal chloride/water/hydrogen chloride system (see Example 5).

This means that a much lower concentration of free hydrochloric acid is required for said method variant according to the invention, whereby on the one hand the method can be used for the first time for the crystallisation of metal chlorides by an increase of hydrogen chloride, and on the other hand the processing of pure hydrochloric acid is reduced, or rather the energy consumption of the entire process is reduced.

The crystallisation according to the invention is operated at temperatures from 10 to 200° C., preferably between 20 and 150° C., and a pressure from −0.8 to 30 bar, preferably −0.5 to 20 bar, and the iron-containing hydrochloric acid solution contains 10 to 70% by weight, preferably 20 to 60% by weight, of iron(III) chloride. The concentration of free hydrogen chloride in said solution is increased to at most 50% by weight, preferably at most 40% by weight.

It is expedient, inter alia, for the separation of non-hydrolysable metal chlorides by means of a crystallisation process from a hydrochloric acid solution, to mix said solution with iron(III)chloride so as to allow crystallisation by increasing the free hydrochloric acid in accordance with the method variant according to the invention. Further, with iron-containing hydrochloric acid solutions, in which the iron is present in bivalent form, said bivalent iron chloride can be converted by oxidation into trivalent iron chloride in the process so as to enable the hydrolysis of iron chloride to iron oxide, preferably haematite.

A key point with this embodiment of the method according to the invention is the hydrogen chloride required for the crystallisation of the metal chlorides. To this end, some of the regenerate obtained from the hydrolysis is removed and pure hydrogen chloride with a concentration of at least 70%, preferably 80% by weight, is obtained in a concentration step from the regenerate and is used for the crystallisation. For the balancing of the water balance, the water separated off from the hydrogen chloride in the concentration step is fed back into the hydrolysis reactor. A chloride circuit is thus produced within the process from the hydrolysis reactor via the concentration step to the crystallisation and via filtrate back to the hydrolysis reactor.

There are different methods for the concentration step, that is to say the production of prepared hydrogen chloride with a purity of at least 70%, preferably at least 80%. On the one hand, the prepared hydrogen chloride can be produced with a purity of at least 70%, preferably at least 80%, via a relatively energy-intensive pressure change rectification. A further possibility lies in bringing the hydrochloric acid into contact with highly concentrated sulphuric acid. Since sulphuric acid is severely hygroscopic, the water contained in the hydrochloric acid or in the regenerate is bound in the sulphuric acid, whereas pure hydrogen chloride can be removed in gaseous form. To increase efficiency, the method can be performed in a number of stages in the counterflow principle. The diluted sulphuric acid can be regenerated in a rectification column.

The key advantage of the last-mentioned method for producing hydrogen chloride compared with direct pressure change rectification of hydrogen chloride is that no azeotropic point has to be skipped with the rectification of sulphuric acid, since the azeotropic point is 96% in the case of sulphuric acid. This provides advantages both in terms of equipment outlay and energy consumption. However, entrainer distillation, in which other metal chlorides are used, such as CaCl₂, is also possible at this juncture.

A further possibility for concentration is provided by membrane distillation, which can be used both directly with pure hydrochloric acid and via the detour with sulphuric acid or with other metal chlorides, for example CalCl₂, as entrainer.

As this method progresses further, it can be modified so as to increase the energy efficiency. Here, the hydrochloric acid solution originating from the metal chloride filtration is conveyed into a pre-evaporator, where a large part of the hydrogen chloride contained in the solution is driven out with energy feed and is recovered as regenerate. The concentrated solution is then pumped from the pre-evaporator into the hydrolysis reactor so as to complete the circuit within the process. The energy required for the pre-evaporation can be made available by the condensation energy of the hydrogen chloride-containing vapours being released from the hydrolysis reactor. Due to the fact that the free hydrochloric acid is driven out from the iron-containing hydrochloric acid solution before the introduction into the hydrolysis reactor, the chloride load in the hydrolysis reactor is reduced, whereby the addition of water to control the salt concentration and the vapour/liquid equilibrium can be reduced in turn. Compared with this, the free hydrogen chloride in WO 2009/153321 is consumed before the hydrolysis reactor by the upstream oxidation reaction. The iron-containing hydrochloric acid solution to be prepared, formed in the production plant, can be introduced both into the pre-evaporator and directly into the hydrolysis reactor.

Continuing, a method variant according to the invention will now be presented which reduces the outlay for the production of the purified hydrochloric acid and is thus more favourable in terms of energy and economic viability. This method variant according to the invention presupposes that the concentration of hydrogen chloride in the hydrogen chloride-containing vapour from the hydrolysis reactor is in the hyperazeotropic range.

The hydrogen chloride-containing vapour from the hydrolysis reactor, with hyperazeotropic hydrogen chloride concentration, is divided here in a concentration process into two fractions—into a hydrogen chloride fraction with a concentration of hydrogen chloride of at least 70%, preferably at least 80%, and a further fraction, which contains at least 10%, preferably at least 15% by weight, of hydrogen chloride, which is fed back directly as regenerated acid to the production process in order to complete the chloride circuit. Besides the methods already mentioned for concentrating hydrogen chloride, a hyperazeotropic rectification column can also be used directly. Here, highly concentrated hydrogen chloride with a concentration of at least 70% by weight, preferably 80% by weight, is obtained as head product. Hydrochloric acid is precipitated as bottom product, of which the concentration corresponds at least to the azeotropic concentration at operating pressure. The azeotropic column is operated at an operating pressure in a range up to at most 50 bar, preferably 30 bar.

The hydrogen chloride-containing vapour from the hydrolysis reactor is condensed on the one hand and is conveyed in liquid form or on the other hand is conveyed directly in vapour form into the concentration. This method variant according to the invention is particularly favourable in terms of energy, since the concentration of hydrochloric acid is not performed above the azeotropic point.

In the hyperazeotropic range, the condensation temperature of a hydrogen chloride-containing vapour with increased hydrogen chloride concentration drops rapidly. At atmospheric pressure, the boiling temperature of the azeotropic mixture, which is approximately 20% by weight hydrogen chloride, is 108° C., and the condensation temperature of pure hydrogen chloride is −70° C. With condensation of hydrogen chloride-containing vapours with hyperazeotropic mixtures, coolants having comparatively low temperatures are therefore necessary so as to fully condense out the hydrogen chloride-containing vapours. For complete condensation of hydrogen chloride-containing vapours with a hydrogen chloride concentration of 35% by weight, a condensation temperature of 71° C. is required. If released condensation energy is used within the process for operation of a pre-evaporator, this temperature level may already be too low, since the condensation energy of the vapours from said pre-evaporator also has to be removed subsequently by means of cooling water. Here, a further lower temperature level is to be taken into account within the process. Should the provided temperature level of the available coolant be too low for complete condensation of the hydrogen chloride-containing vapours from the hydrolysis reactor, it is therefore necessary to additionally inject water into said vapours from the hydrolysis reactor, preferably water from within the process, so as to prevent dilution of the regenerated acid and so as to shift the concentration of the hydrogen chloride-containing vapours from the hydrolysis reactor in the direction of the azeotropic point. By reducing the concentration of the hydrogen chloride in said vapours, for example from 35% to 27%, the temperature range for the complete condensation is raised from 71-107° C. to 100-108° C. Since, in the process, the concentration of the hydrogen chloride in the hydrogen chloride-containing vapour from the hydrolysis reactor is not measured in-situ, there is no need for automatic control of the water injection in order to reduce the concentration of the hydrogen chloride in said vapour. However, when carrying out the method variant according to the invention in which the prepared hydrogen chloride is produced with a purity of at least 70, preferably at least 80%, with a hyperazeotropic rectification column, it is indispensable that a hyperazeotropic hydrogen chloride concentration is present in spite of dilution of the hydrogen chloride-containing vapour from the hydrolysis reactor.

It is therefore expedient to produce the hyperazeotropic hydrochloric acid for the production of pure hydrogen chloride in accordance with the method variant according to the invention, since the condensation of the hydrogen chloride-containing vapours from the hydrolysis reactor is performed in two stages, whereby the process control is considerably simplified. in the first condensation stage, the hyperazeotropic vapour from the hydrolysis reactor is partly condensed at low condensation temperature and is conveyed into said hydrogen chloride concentration. The hydrogen chloride-containing vapours from the hydrolysis reactor not condensed out in the first condensation step are condensed out in a further condensation step. For this purpose, water is additionally injected into the hydrolysis vapour. The concentration of the hydrogen chloride is shifted here in the direction of the azeotropic point, whereby the condensation temperature of the hydrogen chloride-containing vapours is increased. Water within the process is preferably used so as not to influence the water balance of the process, which leads to dilution of the regenerated acid.

In the field of hydrometallurgy, by decomposing ores with hydrochloric acid, metals are separated from the ore. The composition of the various ores is different from deposit to deposit and it is often generally the case that concentrations of substances of value, such as rare earths, are in the ppm range, whereas the main constituent is iron. Other non-hydrolysable metal chlorides, such as: CaCl₂, MgCl₂, NaCl, KCl, are also contained, wherein the concentrations are in ranges of a few % by weight.

Further, Harris et al. describes in “The Jaguar Nickel Inc. Sechol Laterite Project Atmospheric Chloride Leach Process”, International Laterite Nickel Symposium; 2004 an ore leaching method in which metal chloride salts, such as magnesium chloride, are added in high concentrations so as to increase the activity of the free hydrochloric acid during the leaching process. Here too, the substance of value, which is nickel in this case, is superimposed in the concentration by another non-hydrolysable metal chloride, that is to say magnesium chloride.

For the recovery of substances of value from an iron-containing hydrochloric acid solution, of which the concentrations in said solution are low compared with other non-hydrolysable metal chlorides, it is therefore necessary to perform the concentration of the non-hydrolysable metal chlorides by hydrolysis of trivalent iron and the selective crystallisation according to the invention by increase of the concentration of the free hydrogen chloride in said solution in a number of stages.

The iron-containing hydrochloric acid solution is conveyed into a hydrolysis reactor, where iron oxide, preferably haematite, and hydrogen chloride are formed by the hydrolysis of trivalent iron. Non-hydrolysable metal chlorides are concentrated during this process. The concentration of the non-hydrolysable metal chlorides in the concentrated iron-containing hydrochloric acid solution is at most 30% by weight, preferably at most 20% by weight, wherein the concentration of the iron(III) chloride in said solution is 30 to 80% by weight, preferably 40% by weight to 75% by weight. The hydrolysis reactor is operated here at temperatures from 150° C. to 300° C., preferably at temperatures from 160° C. to 200° C., and at a pressure from −0.8 bar to 20 bar, preferably at −0.5 bar to 10 bar. The hydrogen chloride concentration in the hydrolysis vapour is 10 to 40% by weight, preferably 15 to 35% by weight.

Some of the concentrated iron-containing hydrochloric acid solution from the hydrolysis reactor is removed from the hydrolysis reactor, and the iron precipitated as iron oxide, preferably haematite, is filtered off. It is possible to cool said concentrated iron-containing hydrochloric acid solution before the further method steps, the filtration and/or the crystallisation, and to dilute said solution where applicable so as to prevent uncontrolled crystallisation of iron(III) chloride. The filtered-off iron-containing hydrochloric acid solution is forwarded in full or in part into the crystallisation. The remaining residue of said iron-containing hydrochloric acid solution is pumped back into the hydrolysis reactor or into an upstream process step, for example: a pre-evaporator. Non-hydrolysable metal chlorides are crystallised out selectively from said solution in the crystallisation reactor by increasing the concentration of free hydrogen chloride in the iron-containing hydrochloric acid solution and are thus separated from iron. The crystallisation is performed at temperatures from 10 to 200° C., preferably between 20 and 150° C., and at a pressure from −0.8 bar to bar, preferably −0.5 to 20 bar. The iron-containing hydrochloric acid solution contains 10 to 70% by weight, preferably 20 to 60% by weight, of iron(III) chloride. The concentration of the free hydrogen chloride in said solution is increased to at most 50% by weight, preferably at most 40% by weight.

The solubility of the non-hydrolysable metal chlorides decreases steadily with increased concentration. The concentration of the free hydrogen chloride in the first crystallisation step can preferably be selected such that the non-hydrolysable metal chlorides, which comprise a multiple of the concentration of the substances of value, are preferably precipitated out in said crystallisation step, whereas the solubility limit of said substances of value is not reached with the provided concentration of free hydrogen chloride in said solution.

Following the filtration of the crystallised non-hydrolysable metal chlorides, the iron-containing hydrochloric acid solution depleted of non-hydrolysable metal chlorides is conveyed into a second hydrolysis reactor, where non-hydrolysable metal chlorides are further concentrated. The salt concentration and therefore the vapour/liquid equilibrium in the hydrolysis reactor are controlled by addition of water, wherein water from within the process is preferred for reasons concerning the water balance. Some of the iron-containing hydrochloric acid solution is again removed from the second hydrolysis reactor, the iron oxide, preferably haematite, is filtered off, and non-hydrolysable metal chlorides are crystallised out and filtered off in a second crystallisation step by increasing the concentration of the free hydrogen chloride.

The fact is that the more highly concentrated metal chlorides contained in the original iron-containing hydrochloric acid solution cannot be crystallised out fully in the first crystallisation step, and therefore reach the second process stage. If the concentration differences of the non-hydrolysable metal chlorides and of the substances of value are far apart, for example CaCl₂ in ranges 1-5% and chlorides of rare earth metals in ranges of 1-1000 ppm, a two-stage method might not be sufficient to concentrate said substances of value, for example: rare earth metals, in the second hydrolysis step in as much as said substances of value can be crystallised out in the second crystallisation step by increasing the free hydrogen chloride concentration. In this case, hydrolysis and crystallisation are repeated a number of times. Following the last crystallisation step, the filtered-off iron-containing hydrochloric acid solution is fed back in one of the upstream process steps.

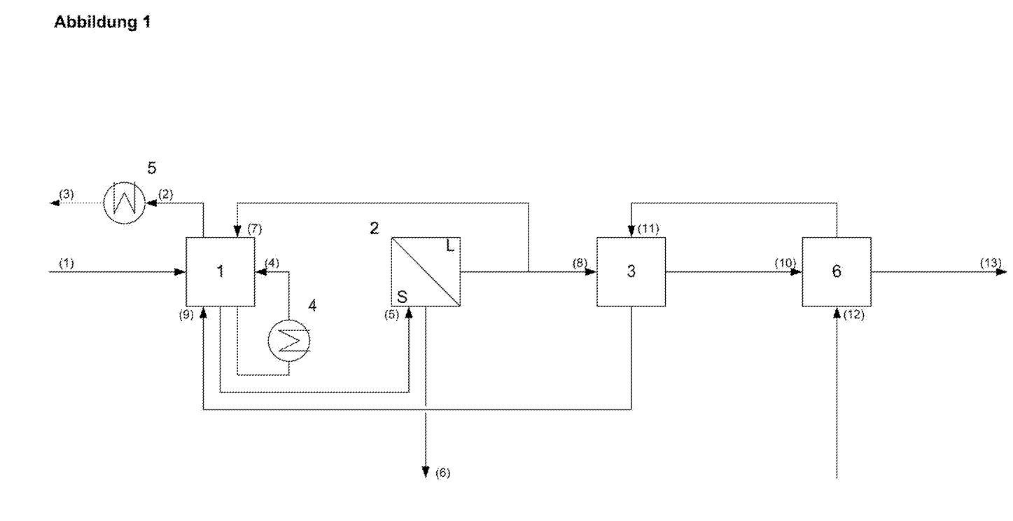

The present invention will now be explained in greater detail with reference to the accompanying drawings, to which the invention is not limited. FIG. 1 illustrates the method according to the invention, in which the non-hydrolysable metal chlorides contained in the iron-containing hydrochloric acid solution are concentrated in the iron-containing hydrochloric acid solution and are then obtained directly and selectively from said iron-containing hydrochloric acid solution in a further method step by means of solvent extraction.

The iron-containing hydrochloric acid solution is pumped via the feed line (1) into the hydrolysis reactor 1, where the hydrolysis reaction takes place. Here, the iron(III) chloride in the solution reacts with water to form hydrochloric acid and iron oxide, preferably haematite, which precipitates from the solution. Non-hydrolysable metal chlorides in the iron-containing hydrochloric acid solution are thus concentrated. Some of the solution is removed from the hydrolysis reactor 1 and is pumped via the circulation line (4) into the external heat exchanger 4, which for example is operated with steam or heat transfer oil. The solution is overheated here in the heat exchanger 4 and is depressurised in the hydrolysis reactor 1 by evaporation of water and hydrogen chloride. This hydrolysis steam is removed via the discharge line (2) from the hydrolysis reactor 1 and is condensed in the condenser 5. The regenerate produced is removed via the drain (3) from the process and is used in turn in the production plant, whereby the chloride circuit is completed.

Before the actual separation of the non-hydrolysable metal chlorides from the iron-containing hydrochloric acid solution by solvent extraction, the iron-containing hydrochloric acid solution removed from the hydrolysis reactor 1 is conveyed via the feed line (5) into the device for filtration 2. The iron oxide, preferably haematite, precipitated from the iron-containing hydrochloric acid solution is filtered off and is ejected from the process via the drain (6). The iron-containing hydrochloric acid filtrate obtained here is pumped at least in part via the feed line (8) into the device 3 for solvent extraction. The remaining filtrate is pumped via the return line (7) back into the hydrolysis reactor 1.

The iron-containing hydrochloric acid solution is brought into direct contact with one or more organic phase(s) not miscible with said solution. The non-hydrolysable metal chlorides are extracted selectively from the iron-containing hydrochloric acid filtrate into the organic phase(s). The iron-containing hydrochloric acid solution freed from the non-hydrolysable metal chlorides is then pumped back from the device 3 via the return line (9) into the hydrolysis reactor 1. The organic solution produced with the extracted metal chlorides is pumped via the feed line 10 into the device 6 in order to strip the organic phase. Water for stripping the organic phase is pumped into the device 6 via the feed line (12). The extracted metal chlorides are extracted from the organic phase into the aqueous phase, and the aqueous phase loaded with the metal chlorides is forwarded via the drain line (13) for the production of metals. The organic phase freed from the non-hydrolysable metal chlorides is fed back from the device 6 via the return line (11) into the device 3 for solvent extraction.

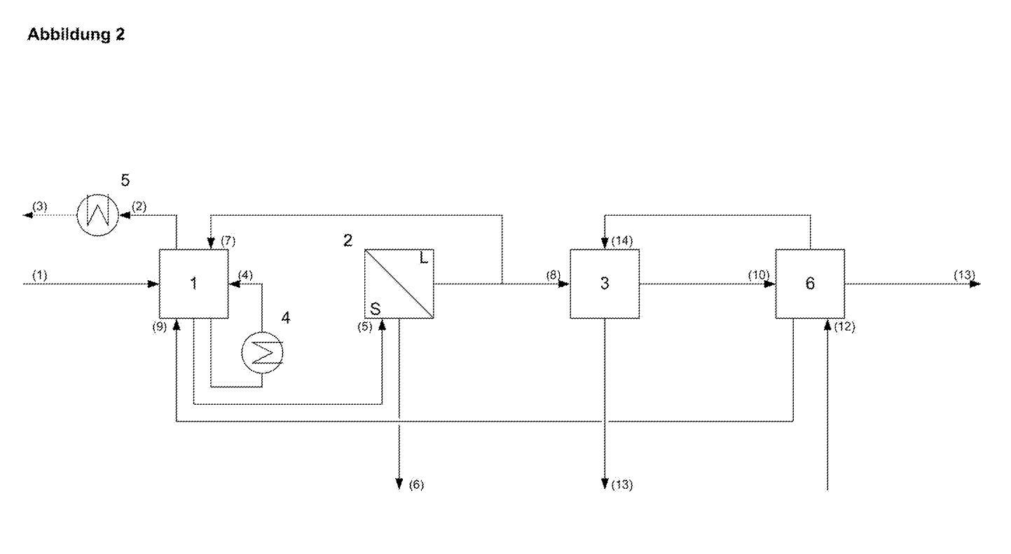

A further embodiment of the method according to the invention is illustrated in FIG. 2, in which the non-hydrolysable metal chlorides contained in the iron-containing hydrochloric acid solution are concentrated and iron is then obtained directly and selectively from said iron-containing hydrochloric acid solution in a further method step by means of solvent extraction. Lines and devices not mentioned explicitly having the same reference numbers are explained in the description of FIG. 1.

In principle, this method is similar to the method described above with reference to FIG. 1, wherein, in the device 3 for solvent extraction, the rest of the iron contained in the solution is also extracted from the aqueous phase into the organic phase. The metal chlorides remaining in the aqueous phase are fed via the drain (13) to further processing steps. The organic phase loaded with iron is pumped via the feed line (10) to the device for stripping the organic phase 6 and is brought into contact with water, which is pumped via the feed line (12) into said device 6. The iron contained in the organic phase is extracted into the aqueous phase and is pumped via the return line (9) back into the hydrolysis reactor 1.

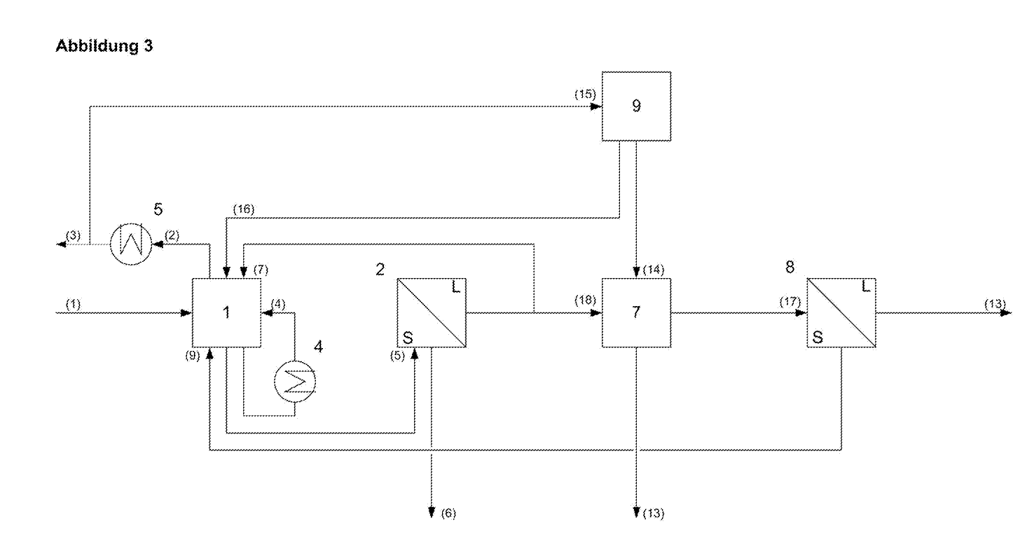

Yet a further embodiment of the method according to the invention is illustrated in FIG. 3, in which the non-hydrolysable metal chlorides contained in the iron-containing hydrochloric acid solution are concentrated in the iron-containing hydrochloric acid solution and said non-hydrolysable metal chlorides are then precipitated out as metal chloride salts in a further method step by increasing the concentration of hydrochloric acid in the concentrated iron-containing hydrochloric acid solution. Lines and devices not explicitly mentioned having the same reference numbers are explained in the description of FIG. 1.

The metal chlorides contained in the iron-containing hydrochloric acid solution to be prepared are concentrated in the hydrolysis reactor 1 in the two previously described method variants. Following the filtration of iron oxide, preferably haematite, in the device for filtration 2, the iron-containing hydrochloric acid filtrate is pumped via the feed line (18) into the crystallisation reactor 7. Prepared hydrogen chloride from the device 9 is introduced, for concentration of hydrogen chloride, via the feed line (14) into the crystallisation reactor 7, where, due to the low solubility of the non-hydrolysable metal chlorides, these are precipitated as metal chloride salts from the solution. Said iron-containing hydrochloric acid solution with the precipitated metal chloride salts are pumped via the feed line (17) into the device for the metal salt filtration 8. The filtrate is pumped via the return line (9) back into the hydrolysis reactor, and the metal chloride salts are removed via the drain (13).

So as to produce the hydrogen chloride required for the crystallisation, some of the regenerate produced in the condenser 5 is pumped via the feed line (15) into the device 9 for concentration of hydrogen chloride. To balance the water balance, the water obtained as a result of the concentration of the hydrogen chloride is fed back into the hydrolysis reactor (1) via the return line (16).

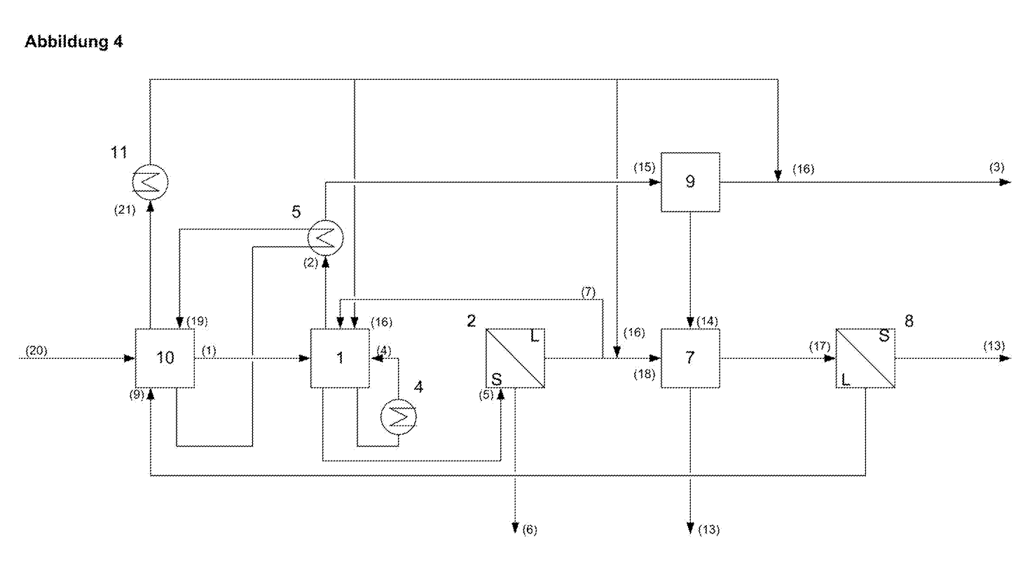

A further embodiment of the present invention is illustrated in FIG. 4. The iron-containing hydrochloric acid solution mixed with non-hydrolysable metal chlorides is conveyed via the feed line (20) into the pre-evaporator 10. In addition, the return line integrates the iron-containing hydrochloric acid solution (9) into the pre-evaporator 10, but can also integrate said solution into the hydrolysis reactor 1 in a possible embodiment. Said iron-containing hydrochloric acid solution is concentrated in the pre-evaporator 10. The energy required for this is provided by the condensation of the hydrogen chloride-containing vapours from the hydrolysis reactor 1. As a possible embodiment, the circulation line for the pre-evaporator (19) is guided via the condenser 5. The iron-containing hydrochloric acid solution in the pre-evaporator is therefore the coolant for the hydrogen chloride-containing vapours from the hydrolysis reactor 1 condensed out in the condenser 5.

The vapours from the pre-evaporator 10 are removed via the discharge line (21) and are condensed out in the condenser for the pre-evaporator 11. The distillate produced as a result is collected and distributed within the process via the return for water 16. Water is required on the one hand in the hydrolysis reactor 1 so as to control there the concentration of the iron-containing hydrochloric acid solution. On the other hand, water is required to dilute, after the filtration, the iron-containing hydrochloric acid solution removed from the hydrolysis reactor 1 so as to avoid uncontrolled crystallisation of iron(III) chloride when cooling said solution. Excess water is ejected from the process via the drain (3) together with the hydrochloric acid produced in the device for the production of hydrogen chloride 9.

It should be noted at this juncture that this method variant according to the invention has a closed water balance. In this respect, it is important to prevent any water from being introduced externally into the process where possible. Under consideration of the balance limit, it is apparent that water and chlorides are introduced into the process exclusively via the feed line (20), whereas, apart from chloride losses by removal of non-hydrolysable metal chlorides from the process via the drain (13), the chlorides and water are ejected from the process as regenerate via the drain (3). The hydrogen chloride concentration in the regenerate that was originally used in the production process thus automatically results. Water that is introduced additionally and externally into the process inevitably leads to the dilution of the regenerate.

The concentrated iron-containing hydrochloric acid solution is transferred via the feed line (1) from the pre-evaporator 10 into the hydrolysis reactor 1. The hydrolysis takes place in the hydrolysis reactor 1, where iron(III) chloride is reacted directly in the solution with water so as to form iron oxide, preferably haematite, which precipitates from the solution, and so as to form hydrogen chloride. Water and hydrogen chloride are removed by evaporation from the hydrolysis reactor 1 via the discharge line (2). Energy is provided externally by incorporating the heat exchanger 4 in the circulation line in the hydrolysis reactor (4). This heat exchanger 4 can be operated with steam or heat transfer oil or other energy transfer media.

At the same time, non-hydrolysable metal chlorides are concentrated in the hydrolysis reactor 1, since they remain in solution, whereas iron is precipitated from the solution as iron oxide, preferably haematite, and water and hydrogen chloride are driven from the solution.

To control the concentration of the metal chlorides of the iron-containing hydrochloric acid solution in the hydrolysis reactor 1, some of the condensed vapours from the pre-evaporator are introduced via the return (16) into the hydrolysis reactor 1.

The vapour/liquid equilibrium in the hydrolysis reactor 1 is of key importance for the design of the process. Besides the concentration of the iron(III) chloride in the iron-containing hydrochloric acid solution in the hydrolysis reactor 1, important influencing variables of the vapour/liquid equilibrium also include the concentrations of the non-hydrolysable metal chlorides.

The hydrogen chloride-containing vapours with hyperazeotropic hydrogen chloride concentration are condensed out in the condenser 5. The released condensation heat is used to heat the pre-evaporator 1. In the present example the temperature level of the available coolant of the iron-containing hydrochloric acid solution in the pre-evaporator 10 is sufficiently low to ensure complete condensation of the hydrogen chloride-containing vapours from the hydrolysis reactor 1. The fully condensed-out hydrogen chloride-containing vapours from the hydrolysis reactor 1 are then conveyed via the feed line (15) into the device for the production of hydrogen chloride 9. The device for the production of hydrogen chloride 9 can be formed as a hyperazeotropic column if the concentration of the hydrogen chloride in the hydrogen chloride-containing vapour from the hydrolysis reactor 1 is hyperazeotropic. Concentrated hydrogen chloride with a concentration of at least 70% by weight, preferably at least 80% by weight, is conveyed as head product via the feed line (14) into the crystallisation reactor 7. The concentration of the hydrogen chloride in the bottom product of the hyperazeotropic column has at least the azeotropic composition at operating pressure of the hyperazeotropic rectification column. It is not possible to skip the azeotropic point by means of a hyperazeotropic rectification. Said bottom product is ejected from the process as regenerate via the drain (3) together with the rest of the condensed vapours from the pre-evaporator 10. Some of the iron-containing hydrochloric acid solution is pumped from the hydrolysis reactor 1 via the feed line (5) to the device for filtration 2. The iron oxide, preferably haematite, formed in the hydrolysis reactor 1 is filtered off from the iron-containing hydrochloric acid solution and is recovered and removed from the process via the drain (6). At least some of the filtrate is pumped via the feed line (18) from the device for filtration 2 into the crystallisation reactor 7. The remainder of the filtrate is pumped back via the filtrate return (7) into the hydrolysis reactor 1. So as to prevent uncontrolled crystallisation of iron(III) chloride when the filtrate is cooled, the filtrate is diluted with water. Here, in the present example, the condensed vapour from the pre-evaporator is mixed with the filtrate via the return (16) before the crystallisation reactor 7. Said return (16) can also be incorporated immediately after the removal of the iron-containing hydrochloric acid solution from the hydrolysis reactor or at any point therebetween.

In the crystallisation reactor 7, the non-hydrolysable metal chlorides are crystallised out from the solution by increasing the concentration of the free hydrogen chloride in the iron-containing solution. The prepared hydrogen chloride is introduced from the device for the production of hydrogen chloride via the feed line for hydrogen chloride (14) into the crystallisation reactor 7. The iron-containing hydrochloric acid solution loaded with precipitated non-hydrolysable metal chlorides is pumped via the feed line (17) into a device for filtering metal chlorides 8. The solid metal chlorides are filtered off in the device for filtration of metal chlorides 8 and are ejected via the drain (13) from the process and are prepared in further process steps. The filtrate is pumped back into the pre-evaporator via the return line (9).

### EXAMPLE 1

In Example 1 a test for determining the vapour/liquid equilibrium of manganese chloride as non-hydrolysable element in a concentrated iron(III) chloride solution at atmospheric pressure is determined. A reflux condenser is installed on an externally heated glass reactor. The solution to be examined is placed in the reactor and is brought to the boil. The temperature is recorded continuously. Once an equilibrium has been reached, the composition of the concentrated iron(III) chloride solution in the glass reactor and in the distillate is analysed. The boiling temperature is also recorded at the time of sample removal.

A test matrix was selected, with which the total concentration of the metal salts (manganese chloride and iron(III) chloride) is 76% by weight. The concentration of the iron(III) chloride clearly decreases with increase of the manganese chloride concentration in the solution.

With increasing manganese chloride concentration, the concentration of the hydrogen chloride in the vapour phase decreases and the boiling temperature likewise falls.

| Concentration of | | |
|---|---|---|
| MnCl₂ in the | Concentration of | |
| iron (III) | HCl in the vapour | |
| chloride solution | phase [% by | Boiling |
| [% by weight] | weight] | temperature [° C.] |
| 0 | 26.4 | 170 |
| 5 | 22.8 | 169 |
| 10 | 19.3 | 167 |
| 15 | 14.1 | 164 |

The present results show that the vapour/liquid equilibrium is significantly influenced by the presence of non-hydrolysable metal chlorides.

### EXAMPLE 2

In a further test the vapour pressure of nickel chloride in the iron(III) chloride solution was determined. The tests were performed on the basis of a total salt concentration of 75% by weight.

| Concentration of | | |
|---|---|---|
| NiCl₂ in the | Concentration of | |
| iron (III) | HCl in the vapour | |
| chloride solution | phase [% by | Boiling |
| [% by weight] | weight] | temperature [° C.] |
| 0 | 23.4 | 168 |
| 2 | 21.7 | 175 |
| 4 | 20.2 | 178 |

In contrast to the vapour/liquid tests of manganese chloride, the boiling temperature of nickel chloride rises with increasing concentration, whereas the concentration of hydrogen chloride in the vapour phase reduces.

### EXAMPLE 3

By increasing the total salt concentration, the boiling temperature and the hydrogen chloride concentration in the vapour phase are increased. A concentrated aqueous iron(III) chloride solution with 72.8% by weight of iron(III) chloride and a nickel concentration of 4.6% by weight has a boiling point of 184° C. The hydrogen chloride concentration in the vapour is 27.6% by weight.

### EXAMPLE 4

A semi-continuous hydrolysis was performed in Example 4. A pure synthetic iron(III) chloride solution with 75% by weight is placed in a heated glass reactor. The vapour is conveyed via a distiller bridge and condensed out. The condensate is collected. The solution in the hydrolysis reactor is brought to the boil. Once the boiling temperature is reached, the feed is introduced into the hydrolysis reactor. The composition of the feed solution is 30% by weight of iron(III) chloride and 2% by weight of nickel chloride. The feed rate was controlled, such that the boiling temperature in the glass reactor is kept constant at 170° C. The test was performed over 3 h, and the concentration of nickel chloride in the iron-containing hydrochloric acid hydrolysis solution is 1.1% by weight at the end of the test. On the whole, approximately 200 g of iron oxide were produced. The nickel concentration in the iron oxide was determined by means of GDMS (glow discharge mass spectroscopy) and was 200 ppm. This test shows that nickel does not hydrolyse and can therefore be concentrated in the hydrolysis reactor.

### EXAMPLE 5

Crystallisation tests for precipitation of nickel chloride from an iron-containing hydrochloric acid solution were performed in Example 5. A synthetic solution of iron(III) chloride and nickel chloride was placed in a crystallisation reactor. At the start of the test, the solution contains 47% by weight of iron(III) chloride and 11% by weight of nickel chloride. Pure hydrogen chloride is injected into the reactor and dissolves in the iron-containing hydrochloric acid solution. The test was performed at 60° C. The temperature was controlled externally by means of thermostats.

| | | Concentration of |
|---|---|---|
| Concentration of | Concentration of | iron (III) |
| free HCl [% by | nickel chloride | chloride [% by |
| weight] | [% by weight] | weight] |
| 1.2 | 10.9 | 46.9 |
| 5.0 | 10.1 | 42.7 |
| 10.7 | 7.4 | 40.5 |
| 14.9 | 0.6 | 45.0 |
| 20.4 | 0.3 | 39.2 |

It is shown in the table how the concentration of nickel chloride and iron chloride develop with an increase of the free hydrogen chloride concentration. At the start, both the concentration of nickel chloride and the concentration of iron(III) chloride in the solution fall. By dissolving hydrogen chloride in the solution, both metal chlorides are “diluted”. From a free hydrogen chloride concentration of 5% by weight, the solubility limit of nickel chloride is reached and this crystallises out. Since the mass loss of the iron-containing hydrochloric acid solution by crystallisation of nickel chloride is not compensated for by the mass gain by dissolution of hydrogen chloride, the iron(III) chloride concentration again decreases from this moment in time. Once nickel chloride has been precipitated almost completely from the solution, the iron(III) chloride concentration falls again by an increase of the free hydrogen chloride concentration.

Once the test has been completed, the solution is filtered off. The filter cake was dissolved in water and analysed by means of ICP-OES. It should be taken into account that the filter cake was not washed for the analysis. The filter cake contains 37% of Ni, 5.7% of Fe and 45% of Cl. The rest is crystal water.

The test showed that it is possible to selectively crystallise a non-hydrolysable metal chloride from an iron(III) chloride solution.

For comparison, the solubility of nickel chloride in the NiCL₂—HCl—H₂O system at 80° C. is presented in the following table (Solubilities on Inorganic and Metalorganic Compounds; Seidell and Linke; 1965).

| Concentration of free HCl | Concentration of nickel |
|---|---|
| [% by weight] | chloride [% by weight] |
| 0.0 | 45.96 |
| 1.0 | 44.00 |
| 3.82 | 39.39 |
| 6.64 | 34.86 |
| 11.54 | 28.09 |
| 15.04 | 22.79 |
| 19.54 | 16.40 |
| 23.2 | 11.12 |
| 26.2 | 8.63 |

With a hydrogen chloride concentration of 26.2% by weight in the NiCl₂—HCl—H₂O system, the solubility of nickel chloride is 8.63% by weight. This means that the solubility limit of nickel chloride is reduced by the presence of iron(III) chloride. For comparison, the solubility of nickel chloride is 0.3% by weight with 39.2% by weight of iron(III) chloride and 20.4% by weight of free hydrogen chloride.

### EXAMPLE 6

A further crystallisation test is performed, in which an iron(III) chloride solution with two non-hydrolysable metal chlorides, nickel chloride and cobalt chloride is performed.

| | Concentration | Concentration | Concentration |
|---|---|---|---|
| Concentration | of nickel | of cobalt | of iron (III) |
| of free HCl [% | chloride [% by | chloride [% | chloride [% by |
| by weight] | weight] | by weight] | weight] |
| 5.9 | 5.3 | 5.1 | 46.9 |
| 6.1 | 4.8 | 4.7 | 42.1 |
| 13.9 | 3.1 | 1.2 | 40.5 |
| 18.1 | 0.5 | 0.7 | 45.0 |
| 20.4 | 0.1 | 1.8 | 39.2 |

The results show that the separation of non-hydrolysable metal chlorides from an iron(III) chloride solution by crystallisation of hydrogen chloride also functions with two non-hydrolysable metal chlorides. The unwashed filter cake at the end of the test contains 9.2% of Fe, 8.5% of Co, 15.2% of Ni and 45% of Cl. The rest is embedded crystal water.

### EXAMPLE 7

A further crystallisation test with cerium(III) chloride was performed.

| | Concentration of | Concentration of |
|---|---|---|
| Concentration of | cerium(III) | iron (III) |
| free HCl [% by | chloride [% by | chloride [% by |
| weight] | weight] | weight] |
| 0 | 10.1 | 53.4 |
| 3.4 | 9.6 | 51.0 |
| 9.5 | 2.2 | 49.8 |
| 12.26 | 0.6 | 51.7 |

The unwashed filter cake, which was obtained once the test had been completed, contains 3.5% by weight of Fe, 34.2% by weight of Ce, and 32% by weight of Cl. The rest is crystal water.

This test shows that chlorides of the rare earth metal cerium can be separated from an iron-containing hydrochloric acid solution by selective crystallisation by means of hydrogen chloride.

### EXAMPLE 8

In example 8 the balance of a process variant according to the invention is shown and is illustrated in FIG. 4, in which an iron-containing hydrochloric acid solution mixed with non-hydrolysable metal chlorides, specifically nickel chloride, is processed. The nickel chloride contained in the iron-containing hydrochloric acid solution is firstly concentrated in the hydrolysis reactor, and said nickel chloride crystallises out in a further method step by increasing the concentration of the free hydrogen chloride in the iron-containing hydrochloric acid solution in the crystallisation reactor and is thus separated from the iron.

In an hour, the process processes 1000 kg of an iron-containing hydrochloric acid solution that is conveyed by the feed line for pre-evaporator (20) into the pre-evaporator 1. Said iron-containing hydrochloric acid solution is composed of 25% by weight of iron(III) chloride and 1% by weight of nickel chloride. In the pre-evaporator 10, the iron-containing hydrochloric acid solution is concentrated by evaporation. The energy required for this, that is to say 500 kW, is provided by the condensation of the hydrogen chloride-containing vapours from the hydrolysis reactor 1. The evaporation is performed at negative pressure so as to lower the boiling point to approximately 60° C. in the pre-evaporator 10. The return of iron-containing hydrochloric acid solution (9) from the device for the filtration of metal chlorides 8 is also incorporated in the pre-evaporator 1. The mass flow of this process return is 450 kg/h and is composed of 44% by weight of iron(III) chloride, 0.5% by weight of nickel chloride and 15% by weight of hydrogen chloride.

775 kg/h of vapours with approximately 6% by weight of hydrogen chloride are removed from the pre-evaporator 10 via the discharge line for pre-evaporator (21) and are condensed out in the condenser for pre-evaporator 11. The released condensation energy, that is to say 510 kW, is removed by means of cooling water. The condensed vapours are pumped within the process via the return of water (16) into the hydrolysis reactor 1 for regulation of the salt concentration (515 kg/h) and into the crystallisation reactor 7 for dilution (125 kg/h). The rest of the water (135 kg/h) is incorporated into the branch line for regenerate (16) and is mixed with the hydrochloric acid removed from the device for the production of hydrogen chloride 9.

It should be noted at this juncture that this method has a closed water balance. The introduction of external water inevitably leads automatically to the dilution of the regenerate. Water and chlorides, incorporated as metal chlorides, are introduced into the process exclusively as iron-containing hydrochloric acid solution via the feed line for the pre-evaporator 11. Apart from chloride losses by removal of nickel chloride from the process via the drain for metal chlorides (13), the chlorides and water are ejected as regenerate from the process in the form of hydrochloric acid via the drain for regenerate (3). The concentration of hydrogen chloride in the regenerate used in the production process is thus provided automatically.

Approximately 675 kg/h of the concentrated iron-containing hydrochloric acid solution are pumped from the pre-evaporator 10 via the feed line to the hydrolysis reactor (1) into the hydrolysis reactor 1. Said concentrated iron-containing hydrochloric acid solution contains approximately 66% by weight of iron(III) chloride and 1.9% by weight of nickel chloride and 3% by weight of free hydrogen chloride.

The hydrolysis takes place in the hydrolysis reactor 1, during which iron(III) chloride reacts with water to form iron oxide, preferably haematite, and hydrogen chloride. The hydrogen chloride and water formed by the hydrolysis reaction are driven by evaporation from the iron-containing hydrochloric acid solution. The thermal energy required for this is 590 kW. Since nickel chloride does not hydrolyse in the hydrolysis reactor 1, but at the same time iron precipitates by hydrolysis as iron oxide, preferably haematite, from the iron-containing hydrochloric acid solution, and water and hydrogen chloride are evaporated, nickel chloride is concentrated in the hydrolysis reactor 1. The iron-containing hydrochloric acid solution in the hydrolysis reactor 1 contains 73% by weight of iron(III) chloride and 4.6% by weight of nickel chloride. The composition of the hydrogen chloride-containing vapour is dependent on the vapour/liquid equilibrium above the iron-containing hydrochloric acid solution in the hydrolysis reactor 1. Besides the concentration of iron(III) chloride, important influencing variables also include the concentration of the non-hydrolysable metal chlorides. The equilibrium concentration of hydrogen chloride in the vapour above the aforementioned iron-containing hydrochloric acid solution is 27.6% by weight with a boiling temperature of 183° C. So as to be able to keep constant the salt concentration in the hydrolysis reactor 1, it is therefore necessary to additionally pump 515 kg/h of water via the return for water (16) into the hydrolysis reactor 1.

790 kg/h of hydrogen chloride-containing vapours are conveyed from the hydrolysis reactor 1 via the discharge line of the hydrolysis reactor (2) into a heat exchanger 5, where they are condensed out fully. The released condensation energy, that is to say 500 kW, is used to heat the pre-evaporator 10. For the complete condensation of the hydrogen chloride-containing vapours from the hydrolysis reactor 1 with a hydrogen chloride concentration of 27.6% by weight, condensation takes place in a temperature range between 107.6° C. and 101° C. The boiling temperature in the pre-evaporator 10 is reduced to 60° C. by applying a negative pressure so as to ensure the heat transfer in the heat exchanger 5.

After the heat exchanger 5, the fully condensed hydrogen chloride-containing vapours are pumped from the hydrolysis reactor 1 via the feed line of regenerate to the device for concentrating hydrogen chloride (15) into the device for the production of hydrogen chloride 9. In the present example, said device for the production of hydrogen chloride 9 is formed as a hyperazeotropic rectification column. As head product, 70 kg/h of hydrogen chloride with a purity of 95% by weight are produced and are conveyed via the feed line of hydrogen chloride (14) into the crystallisation reactor 7. As bottom product, 720 kg/h of hydrochloric acid with a hydrogen chloride concentration of 21% by weight are produced. Said concentrated hydrochloric acid is mixed with the condensed vapours from the pre-evaporator 10 (135 kg/h), which are not required with the process, and is ejected from the process as regenerated acid via the drain for regenerate (3). The process produces 860 kg/h of hydrochloric acid with a concentration of 19% by weight.

The heat output for the hydrogen chloride preparation required for the operation of the hyperazeotropic rectification column is 40 kW, and the required cooling output at the column head is 10 kW.

400 kg/h of iron-containing hydrochloric acid solution are removed from the hydrolysis reactor 1 and are conveyed via the feed line to the filtration device (5) into the device for filtration 2, where 120 kg/h of iron oxide are filtered off from the iron-containing hydrochloric acid solution and are ejected from the process via the drain for iron oxide (6).

270 kg/h of filtrate are conveyed from the device for filtration 2 via the feed line to the filtration device (18) into the crystallisation reactor 7. In order to prevent uncontrolled crystallisation of iron(III) chloride as the filtrate is cooled, the filtrate is mixed with condensed vapours from the pre-evaporator 10 (125 kg/h). The diluted filtrate contains 50% by weight of iron(III) chloride and 3.2% by weight of nickel chloride. 70 kg/h of concentrated hydrogen chloride are introduced into the crystallisation reactor 7 via the feed line for hydrogen chloride (14). The crystallisation reactor is operated at 60° C. Here, the concentration of the free hydrogen chloride in the iron-containing hydrochloric acid solution in the crystallisation reactor 7 is increased to 15% by weight. The solubility of nickel chloride is 0.6% by weight under these operating conditions.

The nickel chloride crystallises out as dihydrate and is filtered off from the iron-containing hydrochloric acid solution in the device for filtration for metal chlorides. 14 kg/h of nickel chloride with 10% by weight of impurities by iron(III) chloride are ejected from the process via the drain for metal chlorides (13) and are processed in further processing steps.

The filtrate from the device for filtration of metal chlorides 8 is fed back into the pre-evaporator 10 via the return of iron-containing hydrochloric acid solutions (9).

The mass flow is 450 kg/h and is composed of 44% by weight of iron(III) chloride, 0.6% by weight of nickel chloride and 15% of free hydrogen chloride.

### KEY

### Devices 1 hydrolysis reactor

2 device for filtration
3 device for solvent extraction
4 heat exchanger
5 condenser
6 device for stripping the organic phase
7 crystallisation reactor
8 device for filtering metal chlorides
9 device for the production of hydrogen chloride
10 pre-evaporator
11 condenser for pre-evaporator

### Lines

(1) feed line to the hydrolysis reactor
(2) discharge line from the hydrolysis reactor
(3) drain for regenerate
(4) circulation line in the hydrolysis reactor
(5) feed line to the filtration device
(6) drain of iron oxide
(7) filtrate return
(8) feed line to the device for solvent extraction
(9) return of the iron-containing hydrochloric acid solution
(10) feed line to the device for stripping the organic phase
(11) return line for the organic phase
(12) feed line for water
(13) drain of the metal chlorides
(14) feed line for hydrogen chloride
(15) feed line for regenerate to the device for concentration of hydrogen chloride
(16) return for water
(17) feed line to the device for filtration of metal chlorides
(18) feed line to the crystallisation reactor
(19) circulation line for pre-evaporator
(20) feed line for pre-evaporator
(21) discharge line for pre-evaporator

1-6. (canceled)

7. A method comprising:
obtaining a solution comprising iron(III) chloride and hydrochloric acid;
precipitating iron from the solution as iron oxide, preferably haematite;
filtering the iron oxide from the solution to form a filtrate; and
removing non-hydrolysable metal chlorides from at least part of the filtrate.

8. The method of claim 7, wherein the iron oxide is further defined as haematite.

9. The method of claim 7, further comprising
removing the non-hydrolysable metal chlorides selectively by solvent extraction from at least part of the filtrate; and
extracting the metal chlorides from an organic phase in a stripping process.

10. The method of claim 9, further comprising performing tailored solvent extraction in series for each metal chloride to be extracted.

11. The method of claim 9, wherein the iron(III) chloride contained in the filtrate is extracted directly by means of solvent extraction.

12. The method of claim 7, further comprising removing the concentrated non-hydrolysable metal chlorides from the filtrate by precipitation caused by increasing concentration of free hydrogen chloride in the filtrate.

13. The method of claim 12, further comprising:
removing regenerate;
concentrating hydrochloric acid from the regenerate; and
using the concentrated hydrochloric acid in a crystallization.
